(19) United States
(12) Patent Application Publication
(10) Pub. No.: US 2026/0370576 A1
(43) Pub. Date: Nov. 19, 2026

(54) ML ASSISTED RAN COGNITIVE TRANSPORT LAYER FOR QOE REGULARIZATION OF UES IN A COMMUNICATION NETWORK SYSTEM

(71) Applicant: Samsung Electronics Co., Ltd., Suwon-si (KR)

(72) Inventors: Vasanth KANAKARAJ, Bangalore, IN (US); Shreyanshu AGARWAL, Bangalore (IN); Swaraj KUMAR, Bangalore (IN); Issaac KOMMINENI, Bangalore (IN); Rahul Kumar SAHA, Bangalore, IN (US); Sukhdeep SINGH, Bangalore, IN (US)

(21) Appl. No.: 19/745,769

(22) Filed: Jul. 17, 2026

Related U.S. Application Data
(63) Continuation of application No. PCT/KR2025/006508, filed on May 14, 2025.

(30) Foreign Application Priority Data
May 14, 2024 (IN) 202441037976
May 6, 2025 (IN) 202441037976

(51) Int. Cl. H04L 41/5019; H04L 41/16; H04L 41/5067

(52) U.S. Cl. CPC H04L 41/5019; H04L 41/16; H04L 41/5067

(57) ABSTRACT

Provided are a method and system for regularization of a QoE for a plurality of UEs in an endpoint of a transport layer (L4) in a communication network system. The method includes: receiving metadata associated with a plurality of UEs connected to a CU in the communication network system through a control plane interface; monitoring KPIs of the plurality of UEs based on the metadata; determining a QoE impact score for each UE of the plurality of UEs based on the KPIs; determining a QoE impact notification based on the QoE impact score determined for each UE of the plurality of UEs that has been impacted; and performing an action for moderation of the QoE based on the QoE impact notification.

### CROSS-REFERENCE TO RELATED APPLICATIONS

This application is a continuation of International Application No. PCT/KR2025/006508 designating the United States, filed on May 14, 2025, in the Korean Ministry of Intellectual Property Receiving Office and claiming priority to Indian Provisional Patent Application No. 202441037976, filed on May 14, 2024, in the Indian Patent Office, and Indian Complete Patent Application No. 202441037976, filed on May 6, 2025, in the Indian Patent Office, the disclosures of each of which are incorporated by reference herein in their entireties.

### BACKGROUND

### Field

The disclosure relates to telecommunication. For example, the disclosure relates to a method and system for managing a quality of experience (QoE) for a user equipment (UE) in a communication network system.

### Description of Related Art

Multi-access edge computing (MEC) servers, when utilized alongside millimetre wave (Mm wave) technology as a wireless medium, can achieve high bandwidth with latency around 30 milliseconds or less. In the context of fifth generation (5G) and sixth generation (6G), Mm wave technology supports the rapid transmission of substantial data volumes, facilitating real-time content capture, representation, and encoding/decoding, which enhances the immersive experience, such as six degrees of freedom (6DoF). This 6DoF capability allows users to experience a fully immersive and realistic experience within their headsets by enabling movement across all six axes of motion. Further, 6DoF grants users greater control over their actions and interactions in a virtual environment, mirroring their experiences in the physical world.

Mm wave technology in 5G and future networks presents distinct challenges related to propagation losses and channel interference caused by factors such as rain, foliage, adverse weather conditions, non-line of sight (LoS) scenarios, and the like. These issues can result in inconsistent QoE for users, manifested through packet reordering, retransmissions in the wireless medium, and increased jitter. The fluctuations in user QoE due to unfavourable conditions in the Mm wave wireless environment pose significant challenges for human-computer interaction applications, including augmented reality (AR), virtual reality (VR), extended reality (XR), non-critical vehicle-to-everything (V2X) applications, edge graphics processing unit (GPU)-based applications, and edge gaming, all of which require a seamless and high-quality user experience. Additionally, the transport layer protocol (Layer 4) at the endpoint does not account for the changing state of the wireless medium, nor does the wireless medium recognize the protocol's state changes.

Intermittent adverse conditions result in numerous retransmissions, packet reordering, and jitter of radio link control (RLC) packets, which creates a cascading impact on the transport layer. As a result, the transport layer reacts slowly to these fluctuating conditions in the wireless medium. This delayed response stems from the separation between the wireless medium and the transport layer in networks. Consequently, this situation leads to inefficient resource utilization and significantly contributes to increased variability in QoE, particularly in Mm wave scenarios.

The above information is presented as background information only to assist with an understanding of the disclosure. No assertion or determination has been made as to whether any of the above might be applicable as prior art with regard to the disclosure.

### SUMMARY

Embodiments of the disclosure provide a method and system for regularization of a QoE for a UE in an endpoint of a transport layer (L4) in a communication network system.

Embodiments of the disclosure may monitor one or more key performance indicators (KPIs) associated with the UEs connected to a centralized unit (CU) in the communication network system.

Embodiments of the disclosure may determine a QoE impact score for each UE based on the one or more KPIs monitored using a QoE prediction ML model.

Embodiments of the disclosure may determine a QoE impact notification based on the QoE impact score determined for each UE.

Embodiments of the disclosure may perform an action for moderation of the QoE based on the QoE impact notification.

According to an example embodiment of the disclosure, a method for managing a QoE for a plurality of UEs in a communication network system is provided. The method includes: receiving metadata associated with a plurality of UEs connected to a centralized unit (CU) in the communication network system through a control plane interface; monitoring one or more key performance indicators (KPIs) of the plurality of UEs based on the metadata received; determining a QoE impact score for each UE of the plurality of UEs based on the one or more KPIs monitored; determining a QoE impact notification based on the QoE impact score determined for each UE of the plurality of UEs that has been impacted; and performing an action for moderation of the QoE based on the QoE impact notification.

According to an example embodiment of the disclosure, a network apparatus for managing a QoE for a plurality of UEs in a communication network system is provided. The network apparatus includes: memory storing instructions and at least one processor, comprising processing circuitry, wherein the instructions, when executed by at least one processor, individually or in any combination, cause the network apparatus to: receive metadata associated with a plurality of UEs connected to a CU in the communication network system through a control plane interface; monitor one or more KPIs of the plurality of UEs based on the metadata received; determine a QoE impact score for each UE of the plurality of UEs based on the one or more KPIs using a QoE prediction machine learning (ML) model; determine a QoE impact notification based on the QoE impact score determined for each UE of the plurality of UEs; and perform an action for moderation of the QoE based on the QoE impact notification.

According to an example embodiment of the disclosure, one or more non-transitory computer-readable storage media storing one or more computer programs including computer-executable instructions that, when executed by at least one processor, comprising processing circuitry, individually or in any combination, of a first user equipment (UE), cause the first UE to perform operations including: receiving metadata associated with a plurality of UEs connected to a CU in the communication network system through a control plane interface, monitoring one or more KPIs of the plurality of UEs based on the metadata received, determining a QoE impact score for each UE of the plurality of UEs based on the one or more KPIs using a QoE prediction machine learning (ML) model, determining a QoE impact notification based on the QoE impact score determined for each UE of the plurality of UEs, and performing an action for moderation of the QoE based on the QoE impact notification.

Other aspects, advantages, and features of the disclosure will become apparent to those skilled in the art from the following detailed description, which, taken in conjunction with the annexed drawings, discloses various example embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1A is a block diagram illustrating an example configuration of a network apparatus implemented to carry out the disclosed subject matter in a virtualized radio access network (vRAN) according to various example embodiments.

FIG. 1B is a block diagram illustrating an example configuration of the network apparatus implemented to carry out the disclosed subject matter in an open radio access network (O-RAN) according to various example embodiments.

FIG. 1C is a block diagram illustrating an example configuration of a QoE Prediction ML Controller of FIG. 1A according to various example embodiments.

FIG. 1D is a block diagram illustrating an example configuration of a QoE Regularization Controller of FIG. 1A according to various example embodiments.

FIG. 2 is a signal flow diagram illustrating an example scenario of QoE regularization in a vRAN deployment according to various example embodiments.

FIG. 3 is a signal flow diagram illustrating an example scenario of QoE regularization in an O-RAN deployment according to various example embodiments.

FIGS. 4A and 4B are flowcharts illustrating an example method for regularization of a QoE in a L4 of a UE in a communication network system according to various example embodiments.

Throughout the drawings, it should be noted that like reference numbers are used to depict the same or similar elements, features, and structures.

### DETAILED DESCRIPTION

The accompanying drawings are provided to assist in understanding of various example embodiments of the disclosure. It includes various specific details to assist in that understanding but these are to be regarded as merely examples. Accordingly, one skilled in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used for a clear and consistent understanding of the disclosure. Accordingly, it should be apparent to those skilled in the art that the following description of various example embodiments of the disclosure is provided for illustration purpose only and not for the purpose of limiting the disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

Various example embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits of a block be implemented by dedicated hardware, or by a processor (e.g., a plurality of programmed microprocessors and associated circuitry), or by a combination of dedicated hardware to perform some functions of the block and a processor to perform other functions of the block. Each block of the various embodiments be physically separated into two or more interacting and discrete blocks without departing from the scope of the disclosed method. The blocks of the various embodiments be physically combined into more complex blocks without departing from the scope of the disclosed method.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like. Thus, the term “processor” as used herein may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The accompanying drawings are used to help understand various technical features and it is understood that the various embodiments presented herein are not limited by the accompanying drawings. As such, the disclosed method will be understood to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

In related art, Mm wave communication in 5G and future networks presents distinct challenges related to propagation losses and channel interference caused by factors such as rain, foliage, and adverse weather conditions, as well as non-line-of-sight (NLOS) scenarios. These issues can result in inconsistent QoE, manifested through packet reordering, retransmissions in the wireless medium, and increased jitter.

The disclosure provides leveraging a machine learning (ML) and time series radio access network (RAN) and related key performance indicators (KPIs) to forecast QoE impact scenarios for future time operations. The QoE prediction ML controller deployed in the centralized unit (CU) hosts the ML model. The model may also be deployed in near-RT real-time RAN intelligent controller (RIC) real-time RAN KPIs are fed to the ML model for predicting QoE disruption events for future time operations. The ML model is trained to identify the trends in KPIs that may lead to QoE disruption. Once the QoE disruption is identified, mitigating actions are initiated by QoE regularization controller through the packet processing controller in the network apparatus. The disclosure thus optimizes packet traffic flow, reduces latency, and prevents/reduces imminent QoE impact for end users of immersive applications by predicting such disruptor events and informing the end points through an existing explicit congestion notification (ECN) mechanism.

The end point's transport layer (L4) protocol is unaware of changes in state of wireless medium and vice-versa. The disclosure aims to address this cross layer isolation of information by establishing permeation of wireless channel/state information over to the transport layer in 5G and beyond networks. The disclosure utilizes RAN KPIs, statistics, metadata for all connected user equipments (UEs) in CU (as CU has real time access to all KPIs from radio unit (RU)+distributed unit (DU)). The disclosure may provide two phases: QoE prediction (achieved by the QoE prediction ML controller) and QoE regularization (achieved by the QoE regularization controller). The QoE prediction ML controller predicts a QE impact score for all connected UEs. The QoE regularization controller identifies flows (for edge server applications, operator configured end-points of internet servers) passing through operator network from/to the affected UEs based on their QoE impact score (if it's more than pre-configured QoE threshold). This list of flows identified by their flow identifier (ID) is shared in a QoE impact notification to the packet processing controller. The packing processing controller at the CU sets explicit congestion notification (ECN) bit in data packets belonging to flows present in the QoE impact notification.

In an embodiment, the disclosure provides two example deployments:

Deployment 1 (vRAN Configuration).

The QoE prediction ML controller and the QoE regularization controller can be deployed in CU of vRAN.

3GPP specification (Source: 3GPP TS 37.817 “Study on enhancement for Data Collection for NR and EN-DC”) provides framework to deploy ML model in CU.

The disclosure leverages this framework, for realization of the QoE prediction ML controller.

The QoE impact notification from the QoE regularization controller will be delivered to the existing packet processing controller within the CU, to enable proactive notification to end-points.

### Deployment 2 (O-RAN Configuration)

The QoE prediction ML controller and the QoE regularization controller can be deployed as xAPPs in near-RT RIC (leveraging the RIC framework of O-RAN).

The KPIs of RU and DU collected by the CU is shared with the QoE prediction ML controller over an E2 interface.

The QoE impact score from the QoE prediction ML Controller is delivered to the QoE regularization controller over a representational state transfer (REST) interface.

The QoE impact notification from the QoE regularization controller (xAPPs) will be delivered to the CU's packet processing controller over the E2 interface.

Thus, enabling the CU to provide a proactive notification to end-points.

The below table 1 illustrates the differences between deployment 1 and deployment 2:

TABLE 1

| Parameters | vRAN (Deployment 1) | O-RAN (Deployment 2) |
|---|---|---|
| Description | Deployment option for | Leverages the RIC Framework of O- |
| | non O-RAN | RAN. |
| | compliant architecture. | |
| QoE Prediction | Deployed in CU | Deployed as an xApp in near RT-RIC |
| ML Controller | | |
| QoE | Deployed in CU | Deployed as an xApp in near RT-RIC |
| Regularization | | |
| Controller | | |
| KPI Monitor | Deployed in CU | Deployed in CU of O-RAN |
| Packet Processing | Deployed in CU | Deployed in CU of O-RAN |
| Component | | |
| Communication | All 4 blocks can use IPC/ | Communication between KPI monitor |
| Mechanism | REST as all | controller and QoE Prediction ML |
| | applications are located | Controller happens over the CU-near |
| | on the CU itself. | RT-RIC interface (E2 |
| | | Interface)Communication between the |
| | | QoE Regularization Controller happens |
| | | over the CU to near RT-RIC interface |
| | | (E2 Interface) |
| | | Communication between the QoE |
| | | Prediction ML Controller and the QoE |
| | | Regularization Controller over IPC- |
| | | REST interface. |

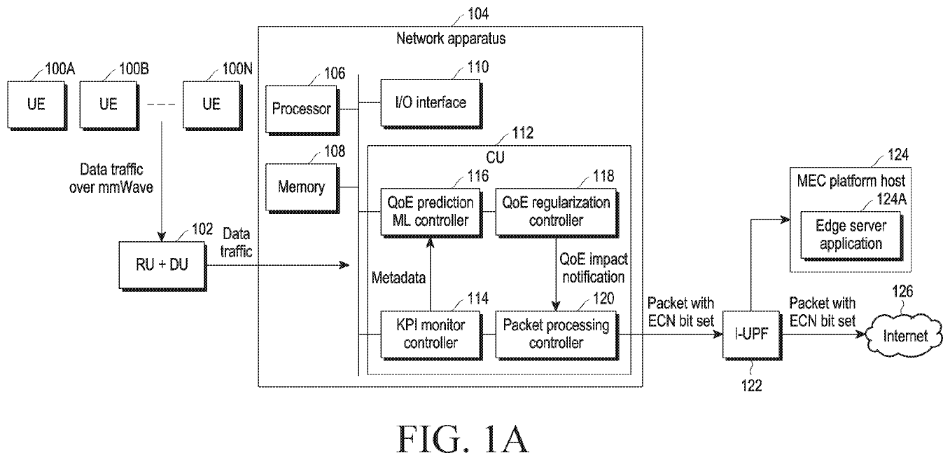

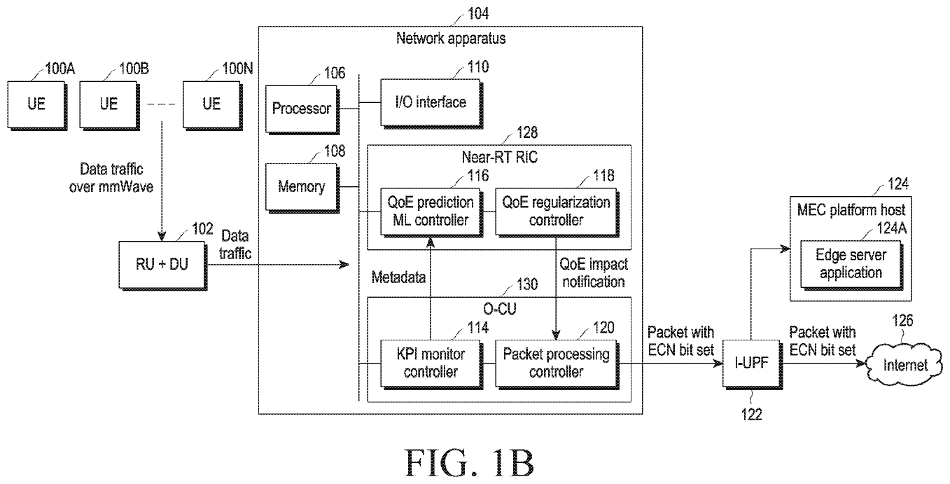

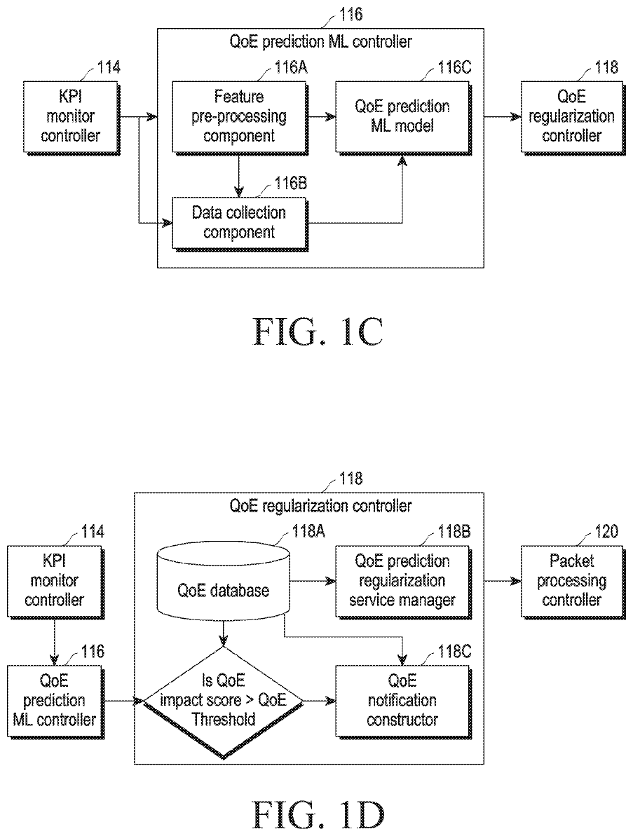

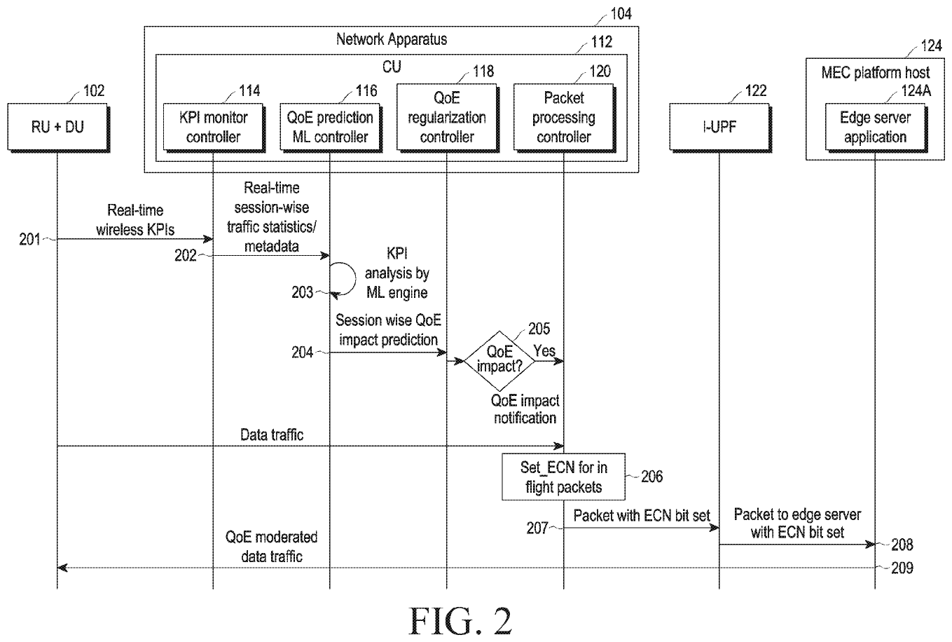

FIG. 1A is a block diagram illustrating an example configuration of a network apparatus (104) implemented to carry out the disclosed subject matter in the vRAN according to various example embodiments. FIG. 1B is a block diagram illustrating an example configuration of the network apparatus (104) implemented to carry out the disclosed subject matter in the O-RAN according to various example embodiments. Examples of the network apparatus (104) may include, but are not limited to, base stations (such as macro cells, small cells, femtocells, pico cells) for wireless communication, antennas and RF units (e.g., multi-input multi-output (MIMO), beamforming) to enhance signal coverage and data throughput, core network equipment (e.g., mobility management entities (MMEs), serving gateways (S-GWs), packet network data gateways (P-GWs) in 4G; access and mobility management functions (AMFs), user plane functions (UPFs) in 5G) for data routing, mobility, and session control, network function virtualization (NFV) and software-defined networking (SDN) for dynamic resource allocation and scalability, edge computing nodes (e.g., multi-access edge computing (MEC) servers) for low-latency processing, backhaul and transport equipment (e.g., fiber-optic links, microwave relays, ethernet switches) to connect base stations to the core network, network management systems (NMS) and operation support systems (OSS) for network configuration, fault management, and optimization, radio network controllers (RNCs) in 3G, DUs, and CUs in 5G, network slicing components for virtualized resource allocation, security elements (e.g., firewalls, inter-domain solution (IDS), authentication, authorization, accounting (AAA) servers) for secure communication.

In FIG. 1A, the network apparatus (104) may include a processor (e.g., including processing circuitry) (106), a memory (108), an input/output (I/O) interface (e.g., including circuitry) (110), and a CU (e.g., including circuitry) (112). The KPI monitor controller (114), the QoE prediction ML controller (116), the QoE regularization controller (118), and the packet processing controller (120) are implemented in the CU (112), which is communicatively coupled to the processor (106) and the memory (108) and may include various circuitry and/or executable program instructions. The KPI monitor controller (114), the QoE prediction ML controller (116), the QoE regularization controller (118), and the packet processing controller (120) may be included in the processor (106).

In FIG. 1B, the QoE prediction ML controller (116) and the QoE regularization controller (118) may be implemented in a near-RT RAN intelligent controller (RIC) (e.g., including circuitry) (128). The KPI monitor controller (114) and the packet processing controller (120) may be implemented in an O-CU (130). The near-RT RIC (128) collects and analyzes RAN data in near-real time and accordingly executes control functions such as, handover management, interference reduction, and load balancing. The O-CU (130) refers to an open architecture that enables flexibility and vendor diversity.

FIGS. 1A and 1B may include a plurality of UEs (100A-N), a RU+DU (102), an intermediate-user plane function (I-UPF) (122), a MEC platform host (124) that includes an edge server application (124A), and an internet (126). The plurality of UEs (100A-N) may include, but are not limited to, consumer electronics (such as mobile phones and smartphones), tablets, wearable devices, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, augmented reality (AR)/extended reality (XR)/virtual reality (VR) devices and controllers etc.). The plurality of UEs (100A-N) may transmit data traffic over the Mm wave to the RU+DU (102). The data traffic from the RU+DU (102) may passe through the CU via the packet processing controller (120). The KPI monitor controller (114) may monitor RAN KPI data, statistics, and metadata for the plurality of UEs (100A-N) of the data traffic flows.

The processor (106) includes various processing circuitry and communicates with the memory (108), the I/O interface (110), and the KPI monitor controller (114), the QoE prediction ML controller (116), the QoE regularization controller (118), and the packet processing controller (120). The QoE prediction ML controller (116), the QoE regularization controller (118), the KPI monitor controller (114), and the packet processing controller (120) use the processor (106), the memory (108), and the I/O Interface (110) of the network apparatus (102). The processor (106) is configured to execute instructions stored in the memory (108) and to perform various processes. The processor (106) may include one or a plurality of processors, is a general-purpose processor such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU). Furthermore, the processor (106) may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory (108) may include storage locations to be addressable through the processor (106). The memory (108) may include metadata associated with the plurality of UEs (100A-N), KPIs monitored upon receiving the metadata, a QoE impact score of each UE session, and a QoE impact notification. The memory (108) is not limited to a volatile memory and/or a non-volatile memory. Further, the memory (108) may include a plurality of computer-readable storage media. The memory (108) may include non-volatile storage elements. For example, non-volatile storage elements may include magnetic hard disks, optical disks, floppy disks, flash memories, or forms of electrically programmable memories (EPROM) or electrically erasable and programmable (EEPROM) memories. The I/O interface (110) may transmit the information between the memory (108) and external peripheral devices. The peripheral devices are the input-output devices associated with the network apparatus (104).

In an embodiment, the KPI monitor controller (114) may include various circuitry and communicate with the I/O interface (110) and the memory (108). The KPI monitor controller (114) may be coupled to the memory (108) and the processor (106). This coupling allows for efficient data transfer and communication between the components, ensuring that the KPI monitor controller (114) may monitor one or more KPIs associated with the plurality of UEs (100A-N). The KPI monitor controller (114) may be an innovative integrated circuit that is implemented in the network apparatus (104). In an embodiment, the structure of such innovative integrated circuit may include a multi-core architecture that enables monitoring KPIs associated with the plurality of UEs (100A-N). Each core is optimized for specific tasks, such as receiving metadata associated with the plurality of UEs (100A-N), monitoring KPIs of the plurality of UEs (100A-N) based on the metadata received, and the like. The innovative integrated circuit for the above-mentioned points is made of a combination of analog and digital components designed to monitor KPIs associated with the plurality of UEs (100A-N). The analog components may include a low-noise amplifier and a high-precision analog-to-digital converter to ensure accurate signal processing. The digital components may include a microcontroller unit (MCU) and a digital signal processor (DSP) that work in tandem to monitor KPIs associated with the plurality of UEs (100A-N).

In an embodiment, the KPI monitor controller (114) may receive metadata associated with the plurality of UEs (100A-N) connected to the CU (112) in the communication network system. For instance, the metadata is received via a control plane interface. The metadata may include session wise traffic statistics associated with each UE of the plurality of UEs (100A-N) within a UE session. The session wise traffic statistics may include RAN KPIs. For example, the RAN KPIs may include UE measurement reports, signal strength, uplink and downlink PRB utilization, packet delay, IP latency, packet discard and drop rates, RAN thermal noise, RAN interference, and the like.

In an embodiment, the KPI monitor controller (114) may monitor one or more KPIs of the plurality of UEs (100A-N) based on the metadata received. The KPIs refer to measurable values that help the KPI monitor controller (114) to monitor the KPIs, store the KPIs, and share the KPIs monitored with the QoE prediction ML controller (116). The monitored KPIs may include a plurality of RAN KPIs associated with the plurality of UEs (100A-N) connected to the CU (112). For instance, the RAN KPIs include, but not limited to measurement reports, downlink PRB utilization, uplink physical resource block (PRB) utilization, average RAN received signal strength indicator (RSSI), average RAN thermal noise, average RAN interference, RAN packet delay in downlink, internet protocol (IP) latency, PDCP PDU discard rate, packet data convergence protocol (PDCP) protocol data unit (PDU) drop rate, RAN handover success rate, RAN downlink data volume, RAN uplink data volume, RAN block error rate (uplink and downlink), downlink retransmissions, and the like.

In an embodiment, the QoE prediction ML controller (116) may communicate with the I/O interface (110) and the memory (108). The QoE prediction ML controller (116) may be coupled to the memory (108) and the processor (106). This coupling allows for efficient data transfer and communication between the components, ensuring that the QoE prediction ML controller (116) may determine a QoE impact score for the plurality of UEs (100A-N). The QoE prediction ML controller (116) is an innovative integrated circuit that is implemented in the network apparatus (104). In an embodiment, the structure of such innovative integrated circuit may include a multi-core architecture that enables determination of a QoE impact score for the plurality of UEs (100A-N). Each core is optimized for specific tasks, such as receiving information associated with the KPIs monitored, determining the QoE impact score for the plurality of UEs (100A-N) using a QoE prediction machine learning (ML) model, and the like. The innovative integrated circuit for the above-mentioned points is made of a combination of analog and digital components designed to determine the QoE impact score for the plurality of UEs (100A-N) using the QoE prediction ML model. The analog components may include a low-noise amplifier and a high-precision analog-to-digital converter to ensure accurate signal processing. The digital components may include a microcontroller unit (MCU) and a digital signal processor (DSP) that work in tandem to determine the QoE impact score for the plurality of UEs (100A-N) using the QoE prediction ML model.

In an embodiment, the QoE prediction ML controller (116) may determine a QoE impact score for each UE of the plurality of UEs (100A-N) based on the one or more KPIs monitored. The QoE impact score may serve as a metric that reflects the probability of experiencing a deterioration in the QoE for various the plurality of UEs (100A-N) that are connected to the CU (112). The QoE impact score may be represented as a floating-point number, which may take on any value between 0 and 1, where 0 indicates no likelihood of decline and 1 signifies a certainty of decline in user experience.

The QoE impact score may be determined for the plurality of UEs (100A-N) identified by an international mobile subscriber identity (IMSI). The IMSI is a unique identifier assigned to each UE of the plurality of UEs (100A-N). The IMSI generally may include 15 digits that include a mobile country code (MCC), a mobile network code (MNC), and a mobile subscriber identification number (MSIN).

In an embodiment, the QoE prediction ML controller (116) may generate a session wise QoE impact prediction output for each UE of the plurality of UEs (100A-N) for all the UE sessions flowing through the CU (112). The UE session refers to a logical communication session between the UEs (100A-N) and the CU (112). Establishment of the UE session enables execution of tasks such as voice communication, internet access, voice over long term evolution (LTE), multimedia streaming, application data transmission, and the like. The session wise QoE impact prediction output is the output of the QoE prediction ML model including the QoE impact score for each UE of the plurality of UEs (100A-N) (identified by their IMSI) session with the CU (112).

In an embodiment, the QoE Regularization Controller (118) may communicate with the I/O interface (110) and the memory (108). The QoE regularization controller (118) is coupled to the memory (108) and the processor (106). This coupling allows for efficient data transfer and communication between the components, ensuring that the QoE regularization controller (118) may determine a QoE impact notification for the plurality of UEs (100A-N). The QoE regularization controller (118) is an innovative integrated circuit that is implemented in the network apparatus (104). In an embodiment, the structure of such innovative integrated circuit may include a multi-core architecture that enables determination of a QoE impact notification for the plurality of UEs (100A-N). Each core may be optimized for specific tasks, such as receiving the QoE impact score determined by the QoE prediction ML controller (116), determining, the QoE impact notification for the plurality of UEs (100A-N) based on the QoE impact score, and the like. The innovative integrated circuit for the above-mentioned points is made of a combination of analog and digital components designed to determine the QoE impact notification for the plurality of UEs (100A-N). The analog components may include a low-noise amplifier and a high-precision analog-to-digital converter to ensure accurate signal processing. The digital components may include a microcontroller unit (MCU) and a digital signal processor (DSP) that work in tandem to determine the QoE impact notification for the plurality of UEs (100A-N).

In an embodiment, the QoE regularization controller (118) may determine the QoE impact notification based on the QoE impact score determined for each UE of the plurality of UEs (100A-N). The QoE impact notification may include a list of flow identifiers requiring QoE moderation. This list is generated/determined based on the QoE impact score, which evaluates the quality of service, along with specific filter criteria established by an operator associated with the plurality of UEs (100A-N). Further, the filter criteria may include flow identifiers that are linked to an IP address designated by the operator, ensuring that the moderation process is targeted and effective.

In an embodiment, the QoE regularization controller (118) may configure a QoE threshold for moderation of the QoE. The QoE threshold is important for managing and regulating the overall QoE that users encounter. By setting this threshold, the QoE Regularization Controller (118) may ensure that the quality of service remains within acceptable limits, thereby enhancing user satisfaction and engagement.

In an embodiment, the QoE Regularization Controller (118) may determine whether the QoE impact score is greater than the QoE threshold. The comparison may be performed for each UE session in which the QoE impact score has been determined.

In an embodiment, the QoE Regularization Controller (118) may identify the QoE impact notification for each UE of the plurality of UEs (100A-N) within each UE session. This identification may occur when the QoE impact score is greater than the QoE threshold. Thus, the QoE regularization controller (118) is able to filter the UEs (100A-N) in an effective manner.

In an embodiment, the QoE regularization controller (118) may identify flow identifiers associated with each UE of the plurality of UEs (100A-N) when the QoE impact score is greater than the QoE threshold. For instance, the flow identifiers may include a source IP, a source port, a destination IP, a destination IP, a destination port, and a protocol associated with the plurality of UEs (100A-N) for which the QoE impact score is greater than the QoE threshold. The source IP refers to an IP address assigned to the plurality of UEs (100A-N) that is used to identify its location. The source port refers to a temporary port number assigned to the plurality of UEs (100A-N) used for identifying a specific application or service. The destination IP refers to an IP address of the server or network apparatus (104) to which the plurality of UEs (100A-N) are communicating with. The destination port is a port number on the network apparatus (104) corresponding to specific services.

In an embodiment, the QoE regularization controller (118) may generate the QoE impact notification upon identification of the flow identifiers. The QoE impact notification may include a list of flow identifiers that require QoE moderation in order to achieve necessary QoE. The QoE moderation refers to the process of monitoring, managing, and optimizing QoE for users in the communication network system. QoE factors include, but not limited to video quality, audio quality, load times, lag/jitter in voice/video, app responsiveness, intermittent network quality issues, and the like.

In an embodiment, the packet processing controller (120) may communicate with the I/O interface (110) and the memory (108). The packet processing controller (120) is coupled to the memory (108) and the processor (106). This coupling allows for efficient data transfer and communication between the components, ensuring that the packet processing controller (120) may performs an action for moderation of the QoE based on the QoE impact notification. The packet processing controller (120) is an innovative integrated circuit that is implemented in the network apparatus (104). In an embodiment, the structure of such innovative integrated circuit may include a multi-core architecture that enables performing an action for moderation of the QoE based on the QoE impact notification. Each core is optimized for specific tasks, such as receiving the QoE impact notification determined by the QoE regularization controller (118), performing the action for moderation of the QoE by setting explicit congestion notification (ECN) bits, and the like. The innovative integrated circuit for the above-mentioned points is made of a combination of analog and digital components designed to perform an action for moderation of the QoE based on the QoE impact notification. The analog components may include a low-noise amplifier and a high-precision analog-to-digital converter to ensure accurate signal processing. The digital components may include a microcontroller unit (MCU) and a digital signal processor (DSP) that work in tandem to performs an action for moderation of the QoE based on the QoE impact notification.

In an embodiment, the packet processing controller (120) may perform the action for achieving moderation of the QoE based on the QoE impact notification determined by the QoE regularization controller (118). The action may be performed by setting ECN bits present within data packets for each UE of the plurality of UEs (100A-N) in which the QoE impact notification has been determined. The data packets are currently in transit for specific flows as provided in the QoE impact notification. Setting the ECN bits of the data packets allows for the proactive transmission of congestion notifications to endpoints of the plurality of UEs (100A-N) for each UE session. This thus aids in the moderation of the QoE for users.

FIG. 1C is a block diagram illustrating an example configuration of the QoE prediction ML controller (116) of FIG. 1A according to various example embodiments. The QoE prediction ML controller (116) is responsible for predicting the QoE impact score for UE sessions connected with the CU (112). As shown, the QoE prediction ML controller (116) may include a feature pre-processing component (116A), a data collection component (116B), and a QoE prediction ML model (116C). Each component may include various circuitry and/or executable program instructions and is explained in greater detail below.

The feature pre-processing component (116A) and the data collection component (116B) may receive KPI data from the KPI monitor controller (114). The KPI monitor controller (114) is responsible for gathering real-time KPI data related to the RAN as well as relevant metadata that pertains to the status of the wireless medium and RAN channels utilized by the plurality of UEs (100A-N). This data collection may occur at regular, consistent intervals to ensure accurate monitoring and analysis of network performance. The feature pre-processing component (116A) pre-processes the KPI data. This may include cleaning, transforming, and organizing the KPI data to ensure that it is accurate, consistent, and usable for various tasks. The feature pre-processing component (116A) may transform the KPI data into a format suitable for analysis and ML model training. The data collection component may store the transformed KPI data temporarily for ML model evaluation and testing. This makes the KPI data readily available.

The QoE prediction ML model (116C) may operate by utilizing processed KPIs related to the RAN. These KPIs are sourced from the KPI monitor controller (114), and serve as input data to the QoE prediction ML model (116C). The QoE prediction ML model (116C) may evaluate the KPI information gathered from all UE sessions that are connected through the CU (112). From this analysis, it may generate a QoE impact score, which is a floating-point value that ranges from 0 to 1. The QoE impact score may quantify the likelihood of experiencing a negative impact on QoE, effectively indicating the probability of QoE degradation for the plurality of UEs (100A-N) within the UE sessions.

The QoE prediction ML model (116C) may produce session wise QoE impact prediction output that details the QoE impact prediction for each session. The session wise QoE impact prediction output encompasses the QoE impact score for each UE of the plurality of UEs (100A-N), which is identified by their IMSI. The predictions that are specific to each UE session are subsequently sent to the QoE regularization controller (118), which is responsible for identifying data flows that necessitate QoE moderation.

The QoE prediction ML model (116C) may undergo a re-evaluation and retraining process to better align with the evolving conditions and behaviors of the RAN. This adaptation is achieved by leveraging historical trends derived from the KPI data. This allows the QoE prediction ML model (116C) to respond effectively to changes in the network environment.

FIG. 1D is a block diagram illustrating an example configuration of the QoE regularization controller (118) of FIG. 1A according to various example embodiments. The QoE regularization controller (118) is responsible for generating actions for QoE moderation based on the session wise QoE impact prediction shared by the QoE prediction ML model (116C). The QoE regularization controller (118) also identifies flows to the edge server application (124A) hosted in the MEC platform host (124) of the operator. As shown, the QoE regularization controller (118) may include a QoE database (118A), a QoE regularization service manager (118B), and a QoE notification constructor (118C). Each component may include various circuitry and/or executable program instructions and is explained in greater detail below.

The QoE database (118A) is responsible for storing and managing a QoE threshold that has been set by an operator. The QoE threshold may serve as a benchmark for evaluating a quality of service provided to users. The QoE database (118A) may also store QoE service IP pools that require QoE moderation. The QoE service IP pools may include IP addresses of different applications. For instance, the applications may include edge server applications, service configured server applications, and the like.

The QoE regularization service manager (118B) is responsible various tasks. The QoE regularization service manager (118B) may provide an interface that enables operators to establish the QoE_threshold, which is essential for the effective implementation of QoE moderation. The QoE regularization service manager (118B) facilitates the administration of the IP pool database, allowing operators to add, remove, or update IP addresses for endpoints that require the QoE regularization service. These IP addresses may come from various sources, including edge server applications or enterprise servers that have subscribed to the QoE regularization service in collaboration with the operator. This comprehensive management may ensure that the QoE regularization service operates smoothly and efficiently, meeting the needs of all users involved.

The QoE notification constructor (118C) is designed to filter flow identifiers based on the operator's specified QoE regularization service IP pool. This filtering process targets flow identifiers that have a QoE impact score greater than the QoE threshold. As a result of this filtering, the QoE notification constructor (118C) may generate a QoE impact notification. The QoE impact notification may contain a comprehensive list of all the flow identifiers that require QoE moderation in order to align with the established QoE standards. The flow identifiers are uniquely defined by a 5-tuple, which identifies each data traffic flow. The 5-tuple may include the following elements: source IP, source port, destination IP, destination port, and protocol.

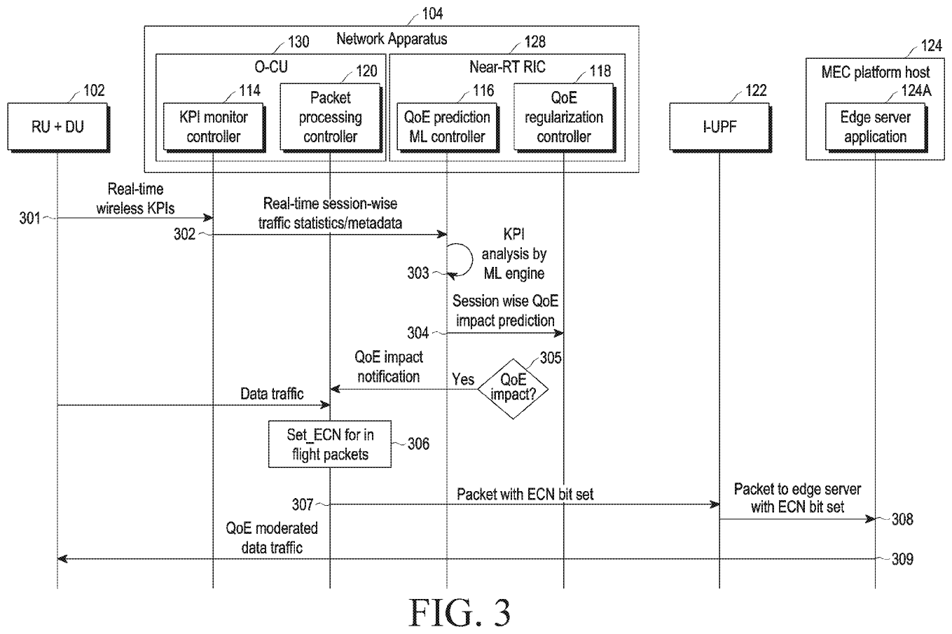

FIG. 2 is a signal flow diagram illustrating an example scenario of QoE regularization in a vRAN deployment according to various example embodiments. Referring to FIG. 2, the RU+DU (102), the network apparatus (104), the I-UPF (122), and MEC platform host (124) in communication with each other. The network apparatus (104) may include the KPI monitor controller (114), the QoE prediction ML controller (116), the QoE regularization controller (118), and the packet processing controller (120) all implemented in the CU (112). Each operation is explained in greater detail below.

At operation 201, the RU+DU (102) may communicate real-time wireless KPI information to the KPI monitor controller (114). Real-time wireless KPI information relates to the continuous monitoring and reporting of KPIs related to a performance of the communication network system. For example, the wireless KPI information may include parameters such as radio quality, throughput, latency, mobility, capacity, reliability, accessibility, and the like associated with the RU+DU (102).

At operation 202, the KPI monitor controller (114) may transmit real-time session-wise traffic statistics/metadata to the QoE prediction ML controller (116). The metadata may include session wise traffic statistics associated with each UE of the plurality of UEs (100A-N) within a UE session.

At operation 203, the QoE prediction ML controller (116) may perform an analysis of the KPIs upon receiving the metadata. For instance, the KPI analysis may be performed using the QoE prediction ML model (116C). Based on the KPI analysis, the QoE prediction ML controller (116) may generate a QoE impact score for each UE of the plurality of UEs (100A-N) within each UE session.

At operation 204, the QoE prediction ML controller (116) may generate a session wise QoE impact prediction output based on the QoE impact score determined for each UE of the plurality of UEs (100A-N) with the UE sessions.

At operation 205, the QoE regularization controller (118) may determine the QoE impact notification based on the QoE impact score determined for each UE of the plurality of UEs (100A-N). The QoE impact notification may include a list of flow identifiers requiring QoE moderation. This list is generated/determined based on the QoE impact score, which evaluates the quality of service, along with specific filter criteria established by an operator associated with the plurality of UEs (100A-N). The QoE impact score is communicated to the packet processing controller (120).

At operation 206, the packet processing controller (120) may perform the action for achieving moderation of the QoE based on the QoE impact notification determined by the QoE regularization controller (118). The action is performed by setting ECN bits present within data packets for each UE of the plurality of UEs (100A-N) in which the QoE impact notification has been determined. The data packets are currently in transit for specific flows as provided in the QoE impact notification.

At operation 207, the packet processing controller (120) may transmit the data packets with the ECN bits set to the I-UPF (122).

At operation 208, the I-UPF (122) may transmit the data packets with the ECN bits set to the edge server application (124A) of the MEC platform host (124).

At operation 209, the edge server application (124A) may determine a QoE moderated data traffic once the ECN bits are set. The edge server application (124A) may transmit the QoE moderated data traffic to the RU+DU (102).

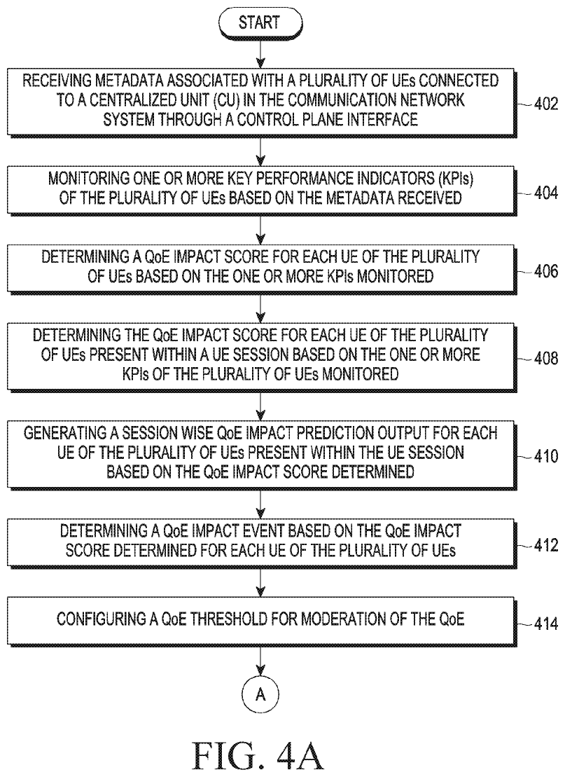

FIG. 3 is a signal flow diagram illustrating an example scenario of QoE regularization in an O-RAN deployment according to various example embodiments. Referring to FIG. 3, the RU+DU (102), the network apparatus (104), the I-UPF (122), and MEC platform host (124) in communication with each other. The network apparatus (104) may include the near-RT RIC (128) and the O-CU (130). The KPI monitor controller (114) and the packet processing controller (120) are implemented in the O-CU (130). The QoE prediction ML controller (116) and the QoE regularization controller (118) are implemented in the near-RT RIC (128). Each operation is explained in greater detail below.

At operation 301, the RU+DU (102) may communicate real-time wireless KPI information to the KPI monitor controller (114). Real-time wireless KPI information relates to the continuous monitoring and reporting of KPIs related to a performance of the communication network system. For example, the wireless KPI information may include parameters such as radio quality, throughput, latency, mobility, capacity, reliability, accessibility, and the like associated with the RU+DU (102).

At operation 302, the KPI monitor controller (114) may transmit real-time session-wise traffic statistics/metadata to the QoE prediction ML controller (116). The metadata may include session wise traffic statistics associated with each UE of the plurality of UEs (100A-N) within a UE session.

At operation 303, the QoE prediction ML controller (116) may perform an analysis of the KPIs upon receiving the metadata. For instance, the KPI analysis may be performed using the QoE prediction ML model (116C). Based on the KPI analysis, the QoE prediction ML controller (116) may generate a QoE impact score for each UE of the plurality of UEs (100A-N) within each UE session.

At operation 304, the QoE prediction ML controller (116) may generate a session wise QoE impact prediction output based on the QoE impact score determined for each UE of the plurality of UEs (100A-N) with the UE sessions. The session wise QoE impact prediction output is transmitted to the QoE regularization controller (118).

At operation 305, the QoE regularization controller (118) may determine the QoE impact notification based on the QoE impact score determined for each UE of the plurality of UEs (100A-N). The QoE impact notification may include a list of flow identifiers requiring QoE moderation. This list is generated/determined based on the QoE impact score, which evaluates the quality of service, along with specific filter criteria established by an operator associated with the plurality of UEs (100A-N). The QoE impact score is communicated to the packet processing controller (120).

At operation 306, the packet processing controller (120) may perform the action for achieving moderation of the QoE based on the QoE impact notification determined by the QoE regularization controller (118). The action is performed by setting ECN bits present within data packets for each UE of the plurality of UEs (100A-N) in which the QoE impact notification has been determined. The data packets are currently in transit for specific flows as provided in the QoE impact notification.

At operation 307, the packet processing controller (120) may transmit the data packets with the ECN bits set to the I-UPF (122).

At operation 308, the I-UPF (122) may transmit the data packets with the ECN bits set to the edge server application (124A) of the MEC platform host (124).

At operation 309, the edge server application (124A) may determine a QoE moderated data traffic once the ECN bits are set. The edge server application (124A) may transmit the QoE moderated data traffic to the RU+DU (102).

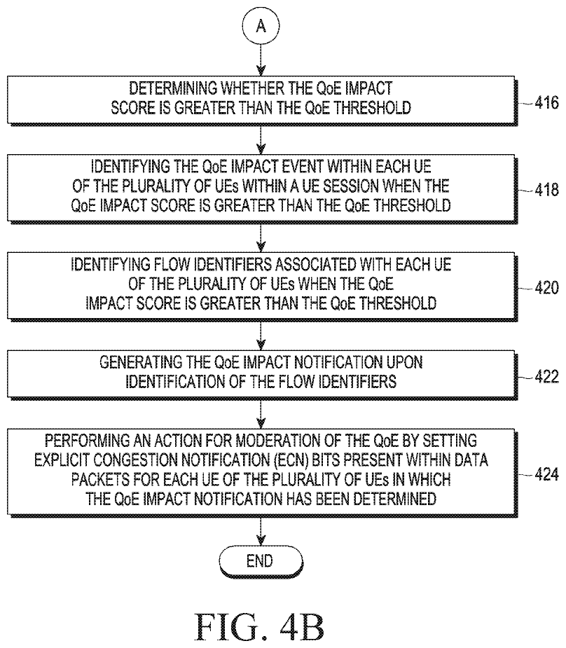

FIGS. 4A and 4B are flowcharts illustrating an example method for regularization of a QoE in a L4 of a UE in a communication network system according to various example embodiments. Each operation is explained in greater detail below.

At operation 402, the KPI monitor controller (114) may receive metadata associated with the plurality of UEs (100A-N) connected to the CU (112) in the communication network system. For instance, the metadata is received via a control plane interface. The metadata may include session wise traffic statistics associated with each UE of the plurality of UEs (100A-N) within a UE session. The session wise traffic statistics may include RAN KPIs. For example, the RAN KPIs may include UE measurement reports, signal strength, uplink and downlink PRB utilization, packet delay, IP latency, packet discard and drop rates, RAN thermal noise, RAN interference, and the like.

At operation 404, the KPI monitor controller (114) may monitor one or more KPIs of the plurality of UEs (100A-N) based on the metadata received. The KPIs refer to measurable values that help the KPI monitor controller (114) track and access an effectiveness of the metadata received. The KPIs monitored include a plurality of RAN KPIs associated with the associated with the plurality of UEs (100A-N) connected to the CU (112). For instance, the RAN KPIs include, but not limited to measurement reports, downlink PRB utilization, uplink PRB utilization, average RAN RSSI, average RAN thermal noise, average RAN interference, RAN packet delay in downlink, IP latency, PDCP PDU discard rate, PDCP PDU drop rate, RAN handover success rate, RAN downlink data volume, RAN uplink data volume, RAN block error rate (uplink and downlink), downlink retransmissions, and the like.

At operation 406, the QoE prediction ML controller (116) may determine a QoE impact score for each UE of the plurality of UEs (100A-N) based on the one or more KPIs monitored. The QoE impact score is a metric that indicates the likelihood of a decline in QoE for the plurality of UEs (100A-N) connected to the CU (112). This score is expressed as a floating-point number ranging from 0 to 1, where 0 indicates there is no chance of deterioration and 1 indicates there is a definite decline in user experience.

At operation 408, the QoE impact score may be determined for the plurality of UEs (100A-N) identified by an international mobile subscriber identity (IMSI). The IMSI is a unique identifier assigned to each UE of the plurality of UEs (100A-N). The IMSI generally may include 15 digits that include a mobile country code (MCC), a mobile network code (MNC), and a mobile subscriber identification number (MSIN). Further, the QoE impact score is determined using the QoE prediction ML model (116C).

At operation 410, the QoE prediction ML controller (116) may generate a session wise QoE impact prediction output for each UE of the plurality of UEs (100A-N) for all the UE sessions flowing through the CU (112). The UE session refers to a logical communication session established between the UEs (100A-N) and the CU (112). Establishment of the UE session enables execution of tasks such as voice communication, internet access, voice over LTE, multimedia streaming, application data transmission, and the like. The session wise QoE impact prediction output is the output of the QoE prediction ML model (116C) including the QoE impact score for each UE of the plurality of UEs (100A-N) (identified by their IMSI) session with the CU (112).

At operation 412, the QoE regularization controller (118) may determine the QoE impact notification based on the QoE impact score determined for each UE of the plurality of UEs (100A-N). The QoE impact notification may include a list of flow identifiers requiring QoE moderation. This list is generated/determined based on the QoE impact score, which evaluates the quality of service, along with specific filter criteria established by an operator associated with the plurality of UEs (100A-N). The filter criteria may include flow identifiers that are linked to an IP address designated by the operator, ensuring that the moderation process is targeted and effective.

At operation 414, the QoE regularization controller (118) may configure a QoE threshold for moderation of the QoE. The QoE threshold is important for managing and regulating the overall QoE that users encounter. By setting this threshold, the QoE regularization controller (118) ensures that the quality of service remains within acceptable limits, thereby enhancing user satisfaction and engagement.

At operation 416, the QoE regularization controller (118) may determine whether the QoE impact score is greater than the QoE threshold. The comparison is performed for each UE session in which the QoE impact score has been determined.

At operation 418, the QoE regularization controller (118) may identify the QoE impact notification for each UE of the plurality of UEs (100A-N) within each UE session. This identification may occur when the QoE impact score is greater than the QoE threshold. Thus, the QoE regularization controller (118) is able to filter the UEs (100A-N) in an effective manner.

At operation 420, the QoE regularization controller (118) may identify flow identifiers associated with each UE of the plurality of UEs (100A-N) when the QoE impact score is greater than the QoE threshold. For instance, the flow identifiers may include a source IP, a source port, a destination IP, a destination IP, a destination port, and a protocol associated with the plurality of UEs (100A-N) for which the QoE impact score is greater than the QoE threshold.

At operation 422, the QoE regularization controller (118) may generate the QoE impact notification upon identification of the flow identifiers. The QoE impact notification may include a list of flow identifiers that require QoE moderation in order to achieve necessary QoE. The QoE moderation refers to the process of monitoring, managing, and optimizing QoE for users in the communication network system. QoE factors may include, but not limited to video quality, audio quality, load times, lag/jitter in voice/video, app responsiveness, network disconnections, and the like.

At operation 424, the packet processing controller (120) may perform the action for achieving moderation of the QoE based on the QoE impact notification determined by the QoE regularization controller (118). The action is performed by setting ECN bits present within data packets for each UE of the plurality of UEs (100A-N) in which the QoE impact notification has been determined. The data packets are presently being transmitted for designated flows as indicated in the QoE impact notification. By configuring the ECN bits of the data packets, congestion notifications may be proactively sent to the endpoints of the plurality of UEs (100A-N) for each UE session. This process contributes to enhancing the QoE for users.

Example Use Case 1A—Augmented Reality (AR) windshield applications: The concept of AR windshields integrates real-world data with virtual enhancements, resulting in a captivating and informative driving experience. The windshield acts as the main display for AR visuals, employing sophisticated head-up display (HUD) technology to project sharp and vibrant images onto its surface. This design ensures a transparent view, enabling drivers to observe both the road and the virtual information superimposed on it. For this technology to function effectively, the digital overlays must integrate with the actual view. A smooth QoE is essential for providing a seamless AR experience in connected vehicles. To achieve a fluid AR experience, it may be desirable to proactively assess and address any factors affecting QoE. The disclosure utilizes ML to analyse trends in wireless medium KPIs and forecast potential QoE impact events based on these trends. By proactively communicating these events to the endpoint, whether it be the content server within the operator's edge network or the internet, AR applications may adjust frame rates, windowing functions, or implement adaptive bitrate streaming to alleviate any QoE issues.

Example Use Case 1B—Connected Car applications in NR V2X: 5G technology may support various applications in connected vehicles through the use of a 5G-enabled telematics control unit (TCU). One main feature is the delivery of AR and VR content for passengers, facilitated by the millimetre wave (Mm wave) 5G TCU. This advancement transforms travel by making high-definition 8K video streaming accessible from every seat in buses and taxis, alleviating the monotony of journeys. Entertainment will extend beyond video streaming, as this technology will enable access to games, live concerts, events, and a range of innovative multimedia services that leverage VR and AR. The disclosure ensures QoE regularization, which allows for the smooth delivery of immersive content via the 5G TCU. An ML model may be developed to forecast channel conditions in the Mm wave spectrum based on KPI trends, ultimately enhancing the user experience.

Example Use Case 2: Digital twin AR/VR applications: Digital twins technology via AR/VR human interactive interfaces are paving the way for transformation across various industries, enabling the creation of virtual replicas of physical systems for advanced monitoring, simulation, and aid in development, training and enhancing user knowledge. They are being explored and implemented for usage across multiple domains. These applications also demand higher QoE than normal applications as they need near real time response for human interactions. The disclosure may provide the needed QoE to a great extent by improving upon latency and jitter

Example Use Case 3: Human Interactive XR Applications such as immersive content streaming (with 6 DoF), VR enhanced video call, social event collaborative virtual streaming, historical exploration by VR, virtual tourism, interactive 3D virtual meetings for professionals, children playing with AR objects, virtual gaming, and the like.

Example Use Case 4: Cloud Gaming: Cloud gaming is a potential use case of 5G mm Wave which is at the confluence of cloud computing and online gaming. It provides the entire game experience to the users remotely from a data-centre. The end device needs a broadband internet connection and the ability to display high definition (HD) video. The disclosure may provide the required QoE to a great extent for cloud gaming by improving upon latency and jitter

Example Use Case 5: Edge Based graphics processing unit (GPU) computing: Edge GPU is also one of the potential use case where, GPU is present in the compute nodes in the edge data centres. This GPU may be used for edge computing applications such as edge AI, edge GPU graphics rendering, and the like. Edge AI involves processing data at the edge of the network, closer to the source of the data. Edge based GPU computing is used to improve the speed and efficiency of data processing, by reducing the amount of data that needs to be transmitted to the cloud or data centre for processing. Edge GPU is a component of smart things as it helps move AI computational power to the edge of the network, where the data is located. Streamlining and improving services and operations may be accomplished by leveraging a huge amount of the data generated by the internet of things (IoT) sensors and creating insights from that data. Edge GPUs are also used in gaming laptops and other mobile devices that require high-performance graphics capabilities while maintaining a low power profile.

While the disclosure has been illustrated and described with reference to various example embodiments thereof, it will be understood by those skilled in the art that various changes in form and details may be made therein without departing from the spirit and scope of the disclosure including the appended claims and their equivalents. It will also be understood that any of the embodiment(s) described herein may be used in conjunction with any other embodiment(s) described herein.

What is claimed is:

1. A method for managing a quality of experience (QoE) for a plurality of user equipments (UEs) in a communication network system, comprising:
receiving, by a network apparatus, metadata associated with a plurality of UEs connected to a centralized unit (CU) in the communication network system through a control plane interface;
monitoring, by the network apparatus, one or more key performance indicators (KPIs) of the plurality of UEs based on the metadata;
determining, by the network apparatus, a QoE impact score for each UE of the plurality of UEs based on the one or more KPIs;
determining, by the network apparatus, a QoE impact notification based on the QoE impact score for each UE of the plurality of UEs; and
performing, by the network apparatus, an action for moderation of the QoE based on the QoE impact notification.

2. The method as claimed in claim 1, wherein the metadata comprises at least one of session wise traffic statistics associated with each UE of the plurality of UEs.

3. The method as claimed in claim 1, wherein the QoE impact notification comprises a list of flow identifiers that require QoE moderation based on the QoE impact score and a filter criteria associated with the plurality of UEs, and wherein the filter criteria comprises flow identifiers associated with an internet protocol (IP).

4. The method as claimed in claim 1, wherein performing, by the network apparatus, the action for moderation of the QoE based on the QoE impact notification comprises:
performing, by the network apparatus, the action for moderation of the QoE by setting explicit congestion notification (ECN) bits present within data packets for each UE of the plurality of UEs in which the QoE impact notification has been determined.

5. The method as claimed in claim 1, wherein the one or more KPIs comprise a plurality of radio access network (RAN) KPIs associated with the plurality of UEs.

6. The method as claimed in claim 1, wherein determining, by the network apparatus, the QoE impact score comprises:
determining, by the network apparatus, the QoE impact score for each UE of the plurality of UEs identified by an international mobile subscriber identity (IMSI) for all UE sessions flowing through the CU based on the one or more KPIs,
wherein the QoE impact score denotes a probability of a QoE degradation within the plurality of UEs, and
wherein the QoE impact score is determined using a QoE prediction machine learning (ML) model.

7. The method as claimed in claim 6, further comprising:
generating, by the network apparatus, a session-wise QoE impact prediction output for each UE of the plurality of UEs for all UE sessions flowing through the CU based on the QoE impact score.

8. The method as claimed in claim 1, wherein determining, by the network apparatus, the QoE impact notification based on the QoE impact score comprises:
configuring, by the network apparatus, a QoE threshold for moderation of the QoE;
determining, by the network apparatus, whether the QoE impact score is greater than the QoE threshold; and
identifying, by the network apparatus, the QoE impact notification within each UE of the plurality of UEs based on the QoE impact score being greater than the QoE threshold.

9. The method as claimed in claim 8, further comprising:
identifying, by the network apparatus, flow identifiers associated with each UE of the plurality of UEs based on the QoE impact score being greater than the QoE threshold; and
generating, by the network apparatus, the QoE impact notification upon identification of the flow identifiers, wherein the QoE impact notification comprises a list of flow identifiers that require QoE moderation.

10. The method as claimed in claim 9, wherein the flow identifiers comprise at least one of a source IP associated with the UEs, a source port associated with the UEs, a destination IP associated with the UEs, a destination IP associated with the UEs, a destination port associated with the UEs, and a protocol associated with the UEs.

11. The method as claimed in claim 1, wherein the QoE for the plurality of UEs is managed in an endpoint of a transport layer in the communication network system.

12. A network apparatus configured to manage a QoE for a plurality of user equipments (UEs) in a communication network system, comprising:
memory storing instructions;
at least one processor, comprising processing circuitry wherein the instructions, when executed by at least one processor individually or in any combination, cause the network apparatus to:
receive metadata associated with a plurality of UEs connected to a central unit (CU), comprising circuitry, in the communication network system through a control plane interface;
monitor one or more KPIs of the plurality of UEs based on the metadata;
determine a QoE impact score for each UE of the plurality of UEs based on the one or more KPIs;
determine a QoE impact notification based on the QoE impact score for each UE of the plurality of UEs; and
perform an action for moderation of the QoE based on the QoE impact notification.

13. The network apparatus as claimed in claim 12, wherein the metadata comprises at least one of session-wise traffic statistics associated with each UE of the plurality of UEs.

14. The network apparatus as claimed in claim 12, wherein the QoE impact notification comprises a list of flow identifiers that require QoE moderation based on the QoE impact score and a filter criteria associated with the plurality of UEs, and wherein the filter criteria comprises flow identifiers associated with an internet protocol (IP).

15. The network apparatus as claimed in claim 12, wherein to perform the action for moderation of the QoE based on the QoE impact notification, the instructions, when executed by at least one processor individually or in any combination, cause the network apparatus to:
perform the action for moderation of the QoE by setting explicit congestion notification (ECN) bits present within data packets for each UE of the plurality of UEs in which the QoE impact notification has been determined.

16. The network apparatus as claimed in claim 12, wherein the one or more KPIs comprise a plurality of radio access network (RAN) KPIs associated with the plurality of UEs.

17. The network apparatus as claimed in claim 12, wherein to determine the QoE impact score, the instructions, when executed by at least one processor individually or in any combination, cause the network apparatus to:
determine the QoE impact score for each UE of the plurality of UEs identified by an international mobile subscriber identity (IMSI) for all UE sessions flowing through the CU based on the one or more KPIs; and
generate a session-wise QoE impact prediction output for each UE of the plurality of UEs for all UE sessions flowing through the CU based on the QoE impact score,
wherein the QoE impact score denotes a probability of a QoE degradation within the plurality of UEs, and
wherein the QoE impact score is determined using a QoE prediction machine learning (ML) model.

18. The network apparatus as claimed in claim 12, wherein to determine the QoE impact notification based on the QoE impact score, the instructions, when executed by at least one processor individually or in any combination, cause the network apparatus to:
configure a QoE threshold for moderation of the QoE;
determine whether the QoE impact score is greater than the QoE threshold; and
identify the QoE impact notification within each UE of the plurality of UEs based on the QoE impact score being greater than the QoE threshold.

19. The network apparatus as claimed in claim 18, wherein the instructions, when executed by at least one processor individually or in any combination, cause the network apparatus to:
identify flow identifiers associated with each UE of the plurality of UEs based on the QoE impact score being greater than the QoE threshold; and
generate the QoE impact notification upon identification of the flow identifiers, wherein the QoE impact notification comprises a list of flow identifiers that require QoE moderation,
wherein the flow identifiers comprise at least one of a source IP associated with the UEs, a source port associated with the UEs, a destination IP associated with the UEs, a destination IP associated with the UEs, a destination port associated with the UEs, and a protocol associated with the UEs.

20. One or more non-transitory computer-readable storage media storing one or more computer programs including computer-executable instructions that, when executed by at least one processor, comprising processing circuitry, individually or in any combination, of a network apparatus, cause the first user equipment (UE) to perform operations, the operations comprising:
receiving metadata associated with a plurality of UEs connected to a CU in the communication network system through a control plane interface;
monitoring one or more KPIs of the plurality of UEs based on the metadata;
determining a QoE impact score for each UE of the plurality of UEs based on the one or more KPIs;
determining a QoE impact notification based on the QoE impact score for each UE of the plurality of UEs; and
performing an action for moderation of the QoE based on the QoE impact notification.
